(19) United States
(12) Patent Application Publication
(10) Pub. No.: US 2025/0138181 A1
(43) Pub. Date: May 1, 2025

(54) VEHICLE AND METHOD FOR VEHICLE COUNTING

(71) Applicant: HELLA GmbH & Co. KGaA, Lippstadt (DE)

(72) Inventor: Ludger WEGHAUS, Lippstadt (DE)

(73) Assignee: HELLA GmbH & Co. KGaA, Lippstadt (DE)

(21) Appl. No.: 18/933,665

(22) Filed: Oct. 31, 2024

(30) Foreign Application Priority Data
Oct. 31, 2023 (DE) 10 2023 130 054.7

(51) Int. Cl. G01S 13/88; G01S 13/10; G01S 13/58

(52) U.S. Cl. CPC G01S 13/88; G01S 13/10; G01S 13/581

(57) ABSTRACT

A vehicle comprising at least one transmitting antenna unit which is configured to transmit a radio signal impulse in a defined transmission frequency range. At least one receiving antenna unit is configured to receive radio signals in the defined transmission frequency range. A computing unit is configured to monitor the signal strength curve of the radio signal received by the receiving antenna unit. The computing unit has a vehicle counting module, which is designed to detect the vehicles passing the vehicle on the basis of the signal strength curve and to add them together to a count value.

This nonprovisional application claims priority under 35 U.S.C. § 119 (a) to German Patent Application No. 10 2023 130 054.7, which was filed in Germany on Oct. 31, 2023, and which is herein incorporated by reference.

### BACKGROUND OF THE INVENTION

### Field of the Invention

The present invention relates to a vehicle and a method for vehicle counting.

### Description of the Background Art

Vehicle counts, also known as traffic surveys, are generally known and serve as a basis for statements about traffic development and as a basis for noise and emission calculations. The vehicle counts or traffic counts can be carried out either manually or automatically. In manual traffic counts, the number of vehicles at intersections is detected with the help of tally sheets. Manual traffic counts are error-prone and time-consuming, as a person has to manually count passing vehicles at a predefined intersection using a tally sheet. In an automatic traffic count, sensor devices are arranged at predefined intersections by means of which the passing vehicles are detected, wherein the sensor signals are evaluated in an evaluation unit and the detected vehicles are added together to form a count value. Automatic traffic counts are time-consuming and cost-intensive, as sensor devices have to be installed at predefined intersections. In addition, such automatic traffic counts can only be carried out at predefined locations with sensor devices permanently pre-installed at the intersections and are therefore inflexible.

### SUMMARY OF THE INVENTION

It is therefore an object of the invention to provide a vehicle with which a traffic count can be carried out in a simple, cost-effective and reliable manner.

The vehicle according to an example of the invention comprises at least one transmitting antenna unit which is configured to emit a radio signal impulse in a defined transmission frequency range, and at least one receiving antenna unit which is set up to receive radio signals in the transmission frequency range.

The transmitting antenna unit and the receiving antenna unit can be based on ultra-wideband (UWB) technology, which is generally known and basically enables data transmission over short distances with a relatively high data transmission rate. Such transmitting antenna units based on ultra-wideband technology and the receiving antenna units are commonly used in vehicle technology. In particular, the transmitting antenna unit and the receiving antenna unit are components of a radio remote control system, the radio remote control system being used to control access to the vehicle. In particular, a signal transmission between the vehicle and a mobile device located in the vicinity of the vehicle detects a person authorized to unlock the vehicle and based on this, the vehicle doors are unlocked or automatically opened. The transmission frequency range used here is preferably 6.5-8.0 GHz.

Due to environmental factors, the radio signal is generally affected during transmission, so the radio signal received by the receiving antenna unit is different from the radio signal emitted by the transmitting antenna unit. In particular, the radio signal received by the receiving antenna unit may include different numbers of reflections of the emitted radio signal depending on the environment. Since the transmission path between the transmitting antenna unit and the receiving antenna unit is also referred to as the radio channel, the radio signal received by the receiving antenna unit is also referred to as the channel impulse response (CIR). Preferably, the transmitting antenna unit is set up to emit a defined sequence of radio signal impulses. The radio signal impulses emitted by the transmitting antenna unit typically have a pulse duration in the range of nanoseconds.

The vehicle also can include a computing unit that is set up to evaluate the signal strength curve of the radio signal received by the receiving antenna unit, preferably a high-pass filtered signal strength curve, in order to detect only moving objects, i.e., passing vehicles and no static objects. The computing unit typically includes a microcontroller or other type of programmable computing unit, wherein the functionality of the computing unit can be realized in hardware and/or software. The computing unit can be realized as a separate component to be mounted on the vehicle or alternatively can also be realized with the transmitting antenna unit and/or the receiving antenna unit in a common device. Furthermore, it is also conceivable that the computing unit is formed by a control unit already present in the vehicle or another programmable computing unit already available, which is at least coupled with the receiving antenna unit and programmed accordingly, for example by importing a software component.

Since the transmitting antenna unit is typically set up to radiate the radio signal impulse into a relatively large solid angle, and the receiving antenna unit is typically set up to receive incoming radio signals from a relatively large solid angle, the received radio signal generally contains one or more reflections of the emitted radio signal impulse, which, due to the longer transmission path, arrive with a delay from the unreflected radio signal impulse at the receiving antenna unit. Here, the number of reflections contained in the received radio signal depends on an effective reflectivity of the environment, which depends in particular on the number, size and surface properties of objects present in the environment. In addition, maximum signal strength generally depends on the effective reflectivity of the environment.

The computing unit can comprise a vehicle counting module, which is designed to detect the vehicles passing the vehicle based on the signal strength curve and to add them together to form a count value. In particular, the vehicle counting module is set up to evaluate the entire so-called CIR of the receiving antenna unit with regard to the detection of a passing vehicle. For example, a number of peaks can be determined within a defined interval of the CIR in order to detect a passing vehicle. Basically, the computing unit can be set up to evaluate any property of the CIR's history, which changes depending on a number of reflections, in order to detect a passing vehicle based on this.

The vehicle counting module can be designed to detect changes in the signal strength curve between different time periods and to detect a passing vehicle based on this. For example, the signal strength curve changes from a weakly reflective environment to a highly reflective environment caused by a vehicle, wherein precisely this change is detected by the vehicle counting module and based on this, it is concluded that a vehicle has driven past.

As soon as a passing vehicle is detected by the vehicle counting module, an increment of a count value is triggered to count the passing vehicles. The count value, which indicates the number of vehicles over a predefined period of time, is preferably stored in a memory of the computing unit and can be retrieved or downloaded at a later time by a corresponding readout process. Alternatively, the count value can also be transmitted automatically, in particular by means of a wireless connection, from the vehicle or from the computing unit to a control center set up for this purpose.

This means that a vehicle count or a traffic count can be carried out in a simple manner using the vehicle, wherein the vehicle only has to be positioned or parked at a place where the vehicle count is to take place. This also provides a relatively high degree of flexibility in vehicle counting or traffic counting, as the vehicle can simply be positioned at almost any location. Also, a technology, namely UWB technology, and the necessary components for vehicle counting are used, which are already present on the vehicle for a different purpose and in a completely different way.

Preferably, the vehicle counting module can be designed to determine the direction of travel, the driving speed and/or the driving side of a passing vehicle based on the signal strength curve. This means that, in addition to vehicle counting, the driving speed, the driving side and/or the direction of travel of passing vehicles can also be detected. Knowledge of the driving speed and direction of travel in particular serves in particular to assess the traffic situation at a certain location.

Preferably, the direction of travel and/or the driving speed of the passing vehicle can be determined using the Doppler effect. The Doppler effect is an apparent change in the frequency of sound, light or radio waves caused by the relative motion between a source and an observer. The frequency increases when both move towards each other. When both move away from each other, the frequency decreases.

When determining the direction of travel, the signal strength curve can be observed and based on this, i.e., based on the frequency development of the signal strength curve, the direction of travel of the passing vehicle can be determined with the knowledge of the direction of the radio signal impulse emitted by the transmitting antenna unit. If the vehicle approaches, the frequency would increase. As soon as the vehicle moves away, the frequency drops. Preferably, the vehicle counting module is designed to determine a count value assigned to a first direction of travel and a count value assigned to a second direction of travel based on the direction of travel. This makes it possible to determine the number of vehicles passing the vehicle in both directions.

When determining the driving speed, the gradient of the frequency change can be evaluated. In addition to vehicle counting, this also allows for the driving speed of passing vehicles to be detected. Knowledge of the driving speed can be used to assess the traffic situation at a certain location.

When determining the driving side, the signal strength curve can be evaluated in such a way that, knowing the position of the receiving antenna unit and the position of the transmitting antenna unit, in particular if the vehicle is positioned off center in the transverse direction of the vehicle, the distance between the antenna units and the currently passing vehicle can be determined from the signal strength curve and thus the driving side can be deduced. The distance can be determined from the signal strength curve by the known sampling frequency and the known speed of light at which the radio signals travel.

Alternatively, the direction of travel, the driving side and/or the driving speed can be determined by several receiving antenna units. For this purpose, the vehicle preferably has several receiving antenna units spaced apart from each other in the transverse direction of the vehicle and/or in the longitudinal direction of the vehicle, each of which is configured to receive radio signals in the transmission frequency range, wherein the signal strength curves of the radio signals received by the several receiving antenna units can be evaluated by the computing unit.

In order to determine the direction of travel and/or the driving speed, several receiving antenna units spaced from each other in the longitudinal direction of the vehicle are provided, wherein the vehicle counting module is designed to determine the direction of travel and/or the driving speed of a passing vehicle by comparing the signal strength curves of the different receiving antenna units. In this case, the signal strength curves of several receiving antenna units are evaluated by the vehicle counting module and compared with each other, wherein the comparison of the two signal strength curves determines a temporal shift of a signal value assigned to the passing vehicle or at least one peak, and from this the direction of travel and/or the driving speed is determined by the known distance between the two receiving antenna units.

To determine the driving side, several receiving antenna units spaced from each other in the transverse direction of the vehicle are preferably provided, wherein the vehicle counting module is designed to determine the driving side of a passing vehicle by comparing the signal strength curves of the different receiving antenna units. The driving side is deduced depending on at which receiving antenna unit a change in the signal strength curve is detected. In particular, one receiving antenna unit is located on the driver's side and another receiving antenna unit is located on the front seat passenger side.

In addition, several transmitting antenna units spaced apart from each other in the transverse direction of the vehicle and/or in the longitudinal direction of the vehicle may also be provided, each of which is set up to emit a radio signal impulse in a defined transmission frequency range, and a control unit which is set up to control the several transmitting antenna units in such a way that the radio signal impulse can optionally be emitted by each of the transmitting antenna units. The several transmitting antenna units are designed to be mounted at different positions on a vehicle and thus make it possible to emit the radio signal impulse optionally from different positions of the vehicle. Preferably, the control unit is set up to operate the several transmitting antenna units sequentially, in such a way that a radio signal impulse is emitted successively from each of the transmitting antenna units.

A communication interface can be provided, which can be connected to a mobile device and/or connected to a user interface located in a vehicle interior, in such a way that the vehicle counting module can be activated by actuation on the mobile device and/or on the user interface. The communication interface is used to activate the vehicle counting module and thus the vehicle counting. As a result, a vehicle count is only carried out if it makes sense. The mobile device can be contactlessly coupled with the communication interface, wherein the mobile device has an application that can be used to activate the vehicle counting process or the vehicle counting module. Otherwise, the vehicle counting module or vehicle count can be activated by a user interface, such as an operating display. Preferably, the start of the measurement and/or the duration of the measurement can be received via the communication interface, wherein the start of the measurement and/or the duration of the measurement can be set by the mobile device or the user interface.

At least one transceiver device comprising both a transmitting antenna unit and a receiving antenna unit is provided, and the transceiver device is set up to operate the transmitting antenna unit and the receiving antenna unit simultaneously. In this way, the transmitting antenna unit as well as a receiving antenna unit can be compactly integrated into a transceiver device, which can reduce the number of components to be assembled. By operating the transmitting antenna unit and the receiving antenna unit at the same time, a radio signal impulse emitted by the transmitting antenna unit of the transceiver device can be reliably received by the receiving antenna unit of the same transceiver device.

The object is further achieved by a method for vehicle counting with a vehicle. For the advantages of the method, reference is made to the preceding paragraphs.

This provides a vehicle and a vehicle counting method that allows for vehicle counting to be carried out in a simple and reliable manner, wherein only the vehicle has to be positioned or parked at a location where the vehicle counting is to take place. Vehicle counting is carried out automatically by the vehicle. This also provides a relatively high degree of flexibility in vehicle counting or traffic counting, as the vehicle can simply be positioned at almost any location. In addition, components already provided on the vehicle for a different purpose can be used for traffic counting.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a vehicle according to an example with a computing unit and four transceiver devices, each comprising a transmitting antenna unit and a receiving antenna unit, as well as two vehicles passing the vehicle,

FIG. 2 shows an example of a signal strength curve of a radio signal received by one of the receiving antenna units from FIG. 1 in response to the emission of a radio signal impulse by one of the transmitting antenna units from FIG. 1 in the case of a weakly reflective vehicle environment, and

FIG. 3 shows an example of a signal strength curve of the radio signal from FIG. 2 in the case of a highly reflective vehicle environment caused by at least one passing vehicle.

### DETAILED DESCRIPTION

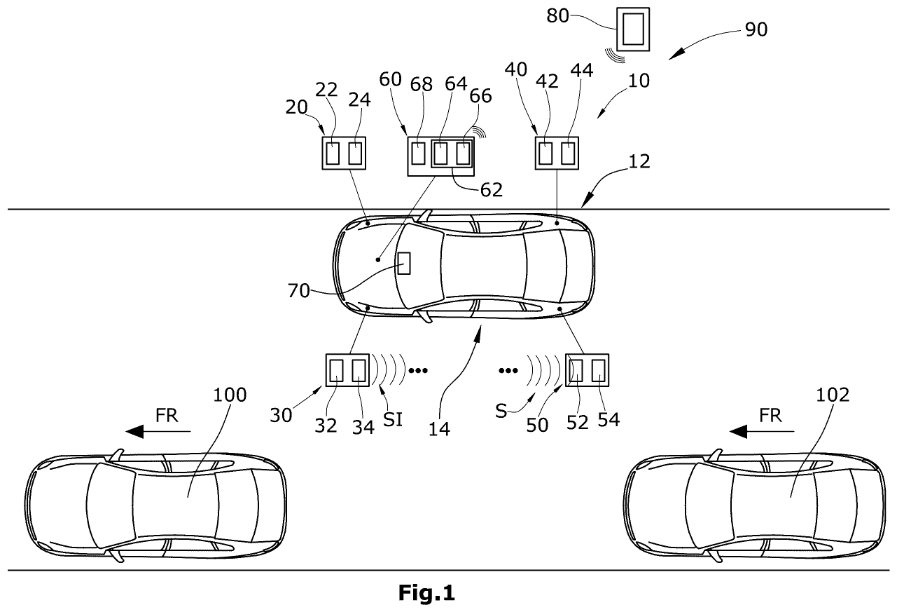

FIG. 1 shows purely schematically a vehicle 10 according to the invention, which comprises four transceiver devices 20, 30, 40, 50 and a control device 60. In addition, FIG. 1 shows two other vehicles 100, 102, wherein the vehicle 10 is standing still and vehicles 100, 102 are passing the vehicle 10.

All transceiver devices 20, 30, 40, 50 on the vehicle 10 are identically designed and each mounted in the area of a bumper or fender of the vehicle 10. In particular, two transceivers 20, 30 are mounted in the front area and two transceiver devices 40, 50 in the rear area of the vehicle 10, wherein the transceiver devices 20, 40 are mounted on the front seat passenger side 12 and the transceiver devices 30, 50 mounted on the driver's side 14.

The four transceiver devices 20, 30, 40, 50 are based on a well-known ultra-wideband technology and each comprise a transmitting antenna unit 22, 32, 42, 52 and a receiving antenna unit 24, 34, 44, 54. In this case, the transmitting antenna unit 22, 32, 42, 52 is set up in a known way to emit a broadband radio signal impulse SI in a defined transmission frequency range, and the receiving antenna unit 24, 34, 44, 54 is set up in a known way to receive radio signals S in the transmission frequency range used by the transmitting antenna unit 22, 32, 42, 52. The four transceiver devices 20, 30, 40, 50 are each set up to operate the respective transmitting antenna unit 22, 32, 42, 52 and the respective receiving antenna unit 24, 34, 44, 54 simultaneously, i.e., to operate them in such a way that the respective receiving antenna unit 24, 34, 44, 54 receives radio signals S, while the respective transmitting antenna unit 22, 32, 42, 52 emits the radio signal impulse SI.

The control device 60 is located in an engine compartment of the vehicle 10 as an example but can in principle be mounted anywhere in the vehicle 10. The control device 60 comprises a computing unit 62 and a control unit 68, and is typically coupled to the four transceivers 20, 30, 40, 50 via a cable connection.

The control unit 68 is set up to control the four transceiver devices 20, 30, 40, 50. In particular, the control unit 68 is set up to control the transceiver devices 20, 30, 40, 50 in such a way that the radio signal impulse SI can be emitted optionally by the transmitting antenna unit 22, 32, 42, 52 of each of the four transceiver devices 20, 30, 40, 50.

The computing unit 62 is set up to evaluate the signal strength curves SV of the radio signals S received by the receiving antenna units 24, 34, 44, 54 of the four transceiver devices 20, 30, 40, 50, in particular a curve of an amount of the so-called CIR of the corresponding receiving antenna unit 24, 34, 44, 54. For this purpose, the computing unit 62 has a vehicle counting module 64 according to the invention, which is designed to detect and count the vehicles 100, 102 passing by the vehicle 10 based on the signal strength curve SV of the receiving antenna units 24, 34, 44, 54, i.e., to add them together to a count value. The count value is stored in a memory of the computing unit 62 and can be retrieved or downloaded at a later time by a corresponding readout process.

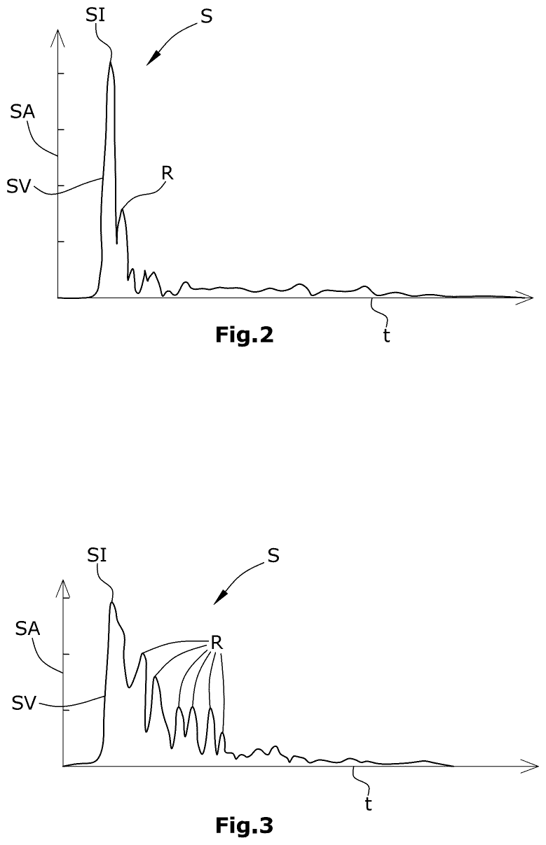

In particular, the vehicle counting module 64 is designed to detect a change in the reflectance and thus the signal strength curves SV, in particular between a highly reflective vehicle environment and a weakly reflective vehicle environment and based on this to detect a passing vehicle 100, 102 and to count all detected, passing vehicles 100, 102. In this case, the signal strength curve SV changes from the weakly reflective vehicle environment, see FIG. 2, to a highly reflective vehicle environment caused by a vehicle 100, 102, see FIG. 3. FIG. 2 and FIG. 3 each show an example of a signal strength curve SV, i.e., the curve of a signal strength SA over a time t, of a radio signal S received by a receiving antenna unit 24, 34, 44, 54 in response to a radio signal impulse SI transmitted by a transmitting antenna unit 22, 32, 42, 52. In particular, FIG. 2 and FIG. 3 each show the curve of an amount of the CIR of the receiving antenna unit 24, 34, 44, 54. In both FIG. 2 and FIG. 3, the unreflected radio signal impulse SI is clearly recognizable at the beginning of the respective signal strength curve SV. Whereas in the signal strength curve SV shown in FIG. 2, i.e., the signal strength curve SV for a weakly reflective vehicle environment, only a single reflection R of the radio signal impulse SI is recognizable in the further curve, in the signal strength curve SV shown in FIG. 3, i.e., the signal strength curve SV for a strongly reflective vehicle environment, a large number of reflections R of the radio signal impulse SI are recognizable in the further curve.

By means of the transceiver devices 20, 30, 40, 50 located on the driver's and front seat passenger's side 12, 14 in the front area and in the rear area, the passing vehicles 100, 102 can be detected on both sides and the driving side 12, 14, the direction of travel FR and the driving speed of the passing vehicles 100, 102 can also be detected.

In order to determine the direction of travel FR and/or the driving speed, the signal strength curves of the receiving antenna units 34, 54 assigned to the driver's side 14 are evaluated by the vehicle counting module 64 and compared with each other, wherein a temporal shift of a signal value assigned to the passing vehicle or at least one peak is determined by comparing the two signal strength curves SV. On the one hand, by knowing the displacement of the peak, the direction of travel FR of the passing vehicle 100, 102 can be determined by determining by which transceiver devices 30, 50 the passing vehicle 100, 102 was first detected in time. On the other hand, the driving speed can be determined by the temporal shift of the peak and the known distance between the two transceiver devices 30, 50. Alternatively, the direction of travel FR and the driving speed of the passing vehicle can be determined by applying a known Doppler effect.

In addition, the driving side 12, 14, i.e., whether the vehicle 100, 102 has driven past the passenger side 12 or the driver's side 14, can be automatically determined by concluding the driving side depending on at which of the receiving antenna units 24, 34, 44, 54 a change in the signal strength curve SV is detected.

The control device 60 or computing unit 62 also includes a communication interface 66 for coupling with a mobile device 80 and/or with a user interface 70 located in a vehicle interior. By coupling the computing unit 62 with the mobile device 80 and/or the user interface 70, the vehicle counting module 64 and thus the vehicle counting can be activated as required. The mobile device 80 can be contactlessly coupled with the communication interface 66, wherein the mobile device 80 has an application through which the vehicle counting process or the vehicle counting module can be activated. Otherwise, the vehicle counting module or vehicle counting can be activated by the user interface 70, which is permanently connected to the vehicle counting module 64, for example an operating display. The mobile device 80 and/or the user interface 70 can also be used to set a measurement start and/or duration in the future. In addition, the communication interface 66 can be bidirectional, which allows for the count value to be transmitted to the mobile device 80.

Thus, a vehicle 10 is provided by means of which the vehicle count can be carried out in a simple and reliable manner, wherein the vehicle 10 only needs to be positioned or parked at a location where the vehicle count is to take place. Vehicle counting is carried out automatically by the vehicle 10. This also provides a relatively high degree of flexibility for the vehicle count or traffic count, as the vehicle 10 can be easily positioned at almost any location.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A vehicle comprising:
at least one transmitting antenna unit that is designed to emit a radio signal impulse in a defined transmission frequency range;
at least one receiving antenna unit configured to receive radio signals in the defined transmission frequency range; and
at least one computing unit configured to evaluate the signal strength of the radio signal received by the receiving antenna unit, the at least one computing unit comprising a vehicle counting module designed to detect vehicles passing the vehicle based on the signal strength curve and to add them together to a count value.

2. The vehicle according to claim 1, wherein the vehicle counting module is designed to determine the direction of travel, a driving side and/or a driving speed of a passing vehicle based on the signal strength curve.

3. The vehicle according to claim 2, wherein the vehicle counting module is designed to determine a count value based on the direction of travel and/or a count value based on the driving side.

4. The vehicle according to claim 2, wherein the vehicle counting module is designed to determine the direction of travel and/or the driving speed of a passing vehicle using a Doppler effect.

5. The vehicle according to claim 1, further comprising:
at least two receiving antenna units spaced apart from each other in a transverse direction of the vehicle and/or in a longitudinal direction of the vehicle, each of the at least two receiving antenna unites being set up to receive radio signals in the transmission frequency range, wherein the signal strength curves of the radio signals received by the receiving antenna units are evaluated by the computing unit, and/or wherein the at least two transmitting antenna units spaced from each other in the transverse direction of the vehicle and/or the longitudinal direction of the vehicle, each of which being configured to emit a radio signal impulse in a defined transmission frequency range; and
a control unit configured to control the several transmitting antenna units such that the radio signal impulse are adapted to optionally be emitted by each of the transmitting antenna units.

6. The vehicle according to claim 2, further comprising:
at least two receiving antenna units spaced from each other in the longitudinal direction of the vehicle, wherein the vehicle counting module is designed to determine the direction of travel and/or the driving speed of a passing vehicle by comparing the signal strength curves of the different receiving antenna units.

7. The vehicle according to claim 2, further comprising:
at least two receiving antenna units spaced in the transverse direction of the vehicle, wherein the vehicle counting module is designed to determine the driving side of a passing vehicle by comparing the signal strength curves of the different receiving antenna units.

8. The vehicle according to claim 1, further comprising:
a communication interface connectable to a mobile device and/or connected to a user interface located in a vehicle interior, such that the vehicle counting module is activated via the mobile device and/or the user interface.

9. The vehicle according to claim 8, wherein a start and/or duration of measurement is received via the communication interface, and wherein the start and/or duration of measurement is adjusted by the mobile device or the user interface.

10. The vehicle according to claim 1, further comprising:
at least one transceiver device comprising a transmitting antenna unit and a receiving antenna unit,
wherein the transceiver device is configured to operate the transmitting antenna unit and the receiving antenna unit substantially simultaneously.

11. The vehicle according to claim 1, wherein the transmitting antenna unit and the receiving antenna unit are assigned to a radio remote control system.

12. The vehicle according to claim 1, wherein the transmitting antenna unit and the receiving antenna unit are based on ultra-wideband technology.

13. The vehicle according to claim 1, wherein the vehicle counting module is designed to detect the vehicles passing by the vehicle based on a high-pass filtered signal strength curve.

14. A method for vehicle counting, the method comprising:
providing a vehicle according to claim 1; and
evaluating the signal strength of the radio signal received by the receiving antenna unit.
